(19) United States
(12) Patent Application Publication
(10) Pub. No.: US 2026/0220351 A1
(43) Pub. Date: Jul. 30, 2026

(54) GENERATIVE ARTIFICIAL INTELLIGENCE SYSTEM TO IMPORT SEMI-UNSTRUCTURED DOCUMENTS INTO A STANDARD FORMAT

(71) Applicant: Schlumberger Technology Corporation, Sugar Land, TX (US)

(72) Inventors: Valerian Guillot, Montpellier (FR); Joan Abadie, Montpellier (FR); Laurent Butre, Paris (FR)

(21) Appl. No.: 19/036,220

(22) Filed: Jan. 24, 2025

(51) Int. Cl. G06F 40/103; G06F 40/205; G06N 3/0475

(52) U.S. Cl. CPC G06F 40/103; G06F 40/205; G06N 3/0475

(57) ABSTRACT

The present disclosure relates to systems and methods for using a generative artificial intelligence system to automatically import data from documents in a standard format. The systems and methods use the generative artificial intelligence system to assist with writing a parsing template to use in converting the data from the documents into the standard format.

### BACKGROUND

Energy companies have access to enormous amounts of data (seismic, well logs, production history, etc.), but struggle to effectively leverage the data that is often in different formats. The energy industry often requires multi-step, interdisciplinary workflows. The data is typically semi structured data (e.g., lithology, core measurements, mud logs surveys) in heterogenous formats that can take months or years to ingest into software for quantitative analysis.

### BRIEF SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some implementations relate to a method. The method includes creating a document snippet of a document in response to determining a document structure is unrecognizable for the document. The method includes generating a prompt with the document snippet and instructions for identifying the document structure of the document. The method includes providing, to a generative artificial intelligence model, the prompt with the document snippet and the instructions. The method includes receiving, from the generative artificial intelligence model, a parsing template generated for the document structure. The method includes generating, using the parsing template, structured data from the document.

Some implementations relate to a device. The device includes a memory to store data and instructions; and a processor operable to communicate with the memory, wherein the processor is operable to: create a document snippet of a document in response to determining a document structure is unrecognizable for the document; generate a prompt with the document snippet and instructions for identifying the document structure of the document; provide, to a generative artificial intelligence model, the prompt with the document snippet and the instructions; receive, from the generative artificial intelligence model, a parsing template generated for the document structure; and generate, using the parsing template, structured data from the document.

Some implementations relate to a computer-readable storage medium including instructions that, when executed by a processor, cause the processor to: create a document snippet of a document in response to determining a document structure is unrecognizable for the document; generate a prompt with the document snippet and instructions for identifying the document structure of the document; provide, to a generative artificial intelligence model, the prompt with the document snippet and the instructions; receive, from the generative artificial intelligence model, a parsing template generated for the document structure; and generate, using the parsing template, structured data from the document.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for using a generative AI system in accordance with implementations of the present disclosure.

FIG. 2 illustrates an example environment for using a multi-modal generative AI system in accordance with implementations of the present disclosure.

FIG. 3 illustrates an example graphical user interface (GUI) of a data management assistant in accordance with implementations of the present disclosure.

FIG. 4 illustrates an example output of structured data from a multi-modal generative AI model in accordance with implementations of the present disclosure.

FIG. 5 illustrates an example method for using a generative AI system in accordance with implementations of the present disclosure.

FIG. 6 illustrates components that may be included within a computer system in accordance with implementations of the present disclosure.

### DETAILED DESCRIPTION

This disclosure generally relates to using generative artificial intelligence (AI) in energy applications. Energy companies have access to enormous amounts of data that is typically in heterogenous formats that can take months or years to ingest into software for quantitative analysis. Majority of the data used during the analysis is in a random structure where each file may have data in a different structure. An expert (usually data managers) typically takes each file used in the analysis and manually converts the data into a common format for the analysis. The process of manually converting the data into a standard format is tedious and time consuming.

When performing assets evaluations in the oil and gas industry to determine whether to purchase an asset, a user typically interprets a portion (e.g., 10%) of the data when evaluating the risk verses potential of an oil and gas reservoir or an asset. For example, an asset screening for an oil field includes 1200 documents in different formats and importing the documents manually into a standard format takes around 2 years. Purchasing decisions are generally unable to wait for the conversion process to complete and users make the purchasing decisions for assets without a complete picture of the data available.

The systems and methods of the present disclosure use a generative system to automatically import data from documents into a standard format. In some implementations, the data is semi-structured data. In some implementations, the data is unstructured data. The systems and methods use a generative AI system to assist with writing a parsing template that provides a set of code to automatically load the data from the documents into a standard format. For example, the standard format data is used for quantitative analysis. Another example includes the standard format data is used within an application in the oil and gas industry. The parsing template is stored in a data repository for future use with data in the same format.

The present disclosure includes a number of practical applications that provide benefits and/or solve problems associated with importing data into a standard format. Examples of these applications and benefits are discussed in further detail below. One example benefit of the systems and methods of the present disclosure is automatically converting the data from the documents into a standard format. Another example benefit of the systems and methods of the present disclosure is reducing an amount of time for importing data from documents into a standard format. By automating the data conversion process, the wellbeing of the users tasked with ensuring the data from the files is converted accurately is improved by reducing tedious and time consuming tasks of the users. Another example benefit of the systems and methods of the present disclosure is making more data available to users during asset evaluations. By reducing an amount of time to convert the data from the documents into a standard format, more data is available to use during asset evaluations.

In some implementations, the generative AI system includes a data management assistant. The data management assistant is an intelligent assistant for data conversion. The data management assistant receives a document and creates a document snippet for the document. The data management assistant generates a prompt with the document snippet and instructions for creating a parsing template to convert the data from the document into a standard format.

In some implementations, the generative AI system use generative AI models to create the parsing template on the fly for the document. The generative AI system identifies on demand whether any of the existing parsing templates are applicable to the data to process. If the generative AI system identifies an existing parsing template, the generative AI system uses the existing parsing template to process the data of the document. If the generative AI system is unable to identify an existing parsing template, the generative AI system uses generative AI models to create the parsing template for the document on demand. Examples of generative AI models include Generative Pre-trained Transformer (GPT) models (e.g., GPT-3 or GPT-4), LlaMA, and GEMINI. Examples of generative AI models also include text-to-image models, such as, DALL-E. Generative AI models generate content, such as text, images, video, audio, or other data in response to a question or prompt. Another example of a generative AI model includes multi-modal models. In some implementations, the prompt is multi-modal input, and the generative AI model processes the multi-modal input to generate content. For example, the generative AI model receives non-text input and generates an output of text. Another example includes, the generative AI model receives text input and generates a non-text output. Generative AI models learn the patterns and structure of the input training data and generate new data that has similar characteristics to the input data in response to prompts.

The generative AI system provides the prompt to a generative AI model with the document snippet and instructions for creating a parsing template. The generative AI model generates a parsing template in response to the instructions provided in the prompt using the document snippet. The systems and methods generate a better prompt using the document snippets resulting in a more accurate response provided by the generative AI models for the document. The generative AI system converts the data from the document in a standard format using the parsing template. The generative AI system provides the standard format data and the parsing template for use, for example, by a user or an application.

One technical advantage of the systems and methods of the present disclosure is automatically creating a parsing template from the provided data. The systems and methods create on the fly a parsing template with code to convert data from a document into a standard format. The systems and methods receive a document snippet for the document and create a parsing template for the document using a prompt created with the document snippet and instructions to convert the data in the document into a standard format. Another technical advantage of the systems and methods of the present disclosure is reducing the time to convert the data from a document into a standard format. Another technical advantage of the systems and methods of the present disclosure is reducing machine resources and networking resources during the conversion of the data resulting in an improvement in computing. By automating the process, the machine resources are used for a shorter duration instead of months or years by a user manually converting the data.

One example use of the systems and methods of the present disclosure is providing the documents for an asset evaluation to the generative AI system to convert the data from the documents into a standard format. A user evaluating an asset (e.g., an oil reservoir, a well, etc.) receives the data in the standard format and uses the data to evaluate the risks versus potential of the asset when making a decision on purchasing the asset.

Another example use of the systems and methods of the present disclosure is providing the documents for evaluating an oil reservoir to the generative AI system to covert the data in the documents into a standard format. The standard format data is used to analyze properties of the oil reservoir and modify a well design in response to the analysis of the oil reservoir. For example, the analysis indicated gravel is located in a portion of the oil reservoir and the wellbore is placed in a different location than the gravel. Another example includes the analysis indicates a formation is at a specific location and the wellbore is placed in a different location than the formation.

Another example use of the systems and methods of the present disclosure is providing documents for use with a quantitative workflow for the oil and gas industry to the generative AI system to convert the data from the documents into a standard format and using the standard format data in the quantitative workflow.

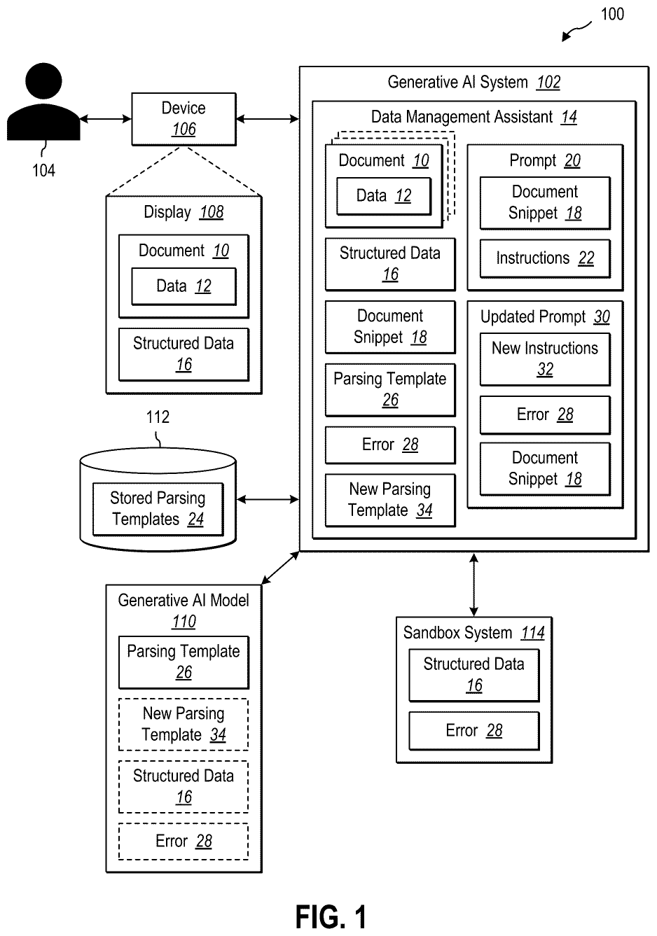

Referring now to FIG. 1, illustrated is an example environment 100 for using a generative AI system 102 to import data 12 from documents 10 into a standard format. In some implementations, the data 12 from the documents 10 is used in analyzing assets in the oil and gas industry. In some implementations, the data 12 from the documents 10 is used to perform workflows in the oil and gas industry. In some implementations, the data 12 from the documents 10 is used in well design for drilling in a reservoir. The generative AI system 102 allows users to import data 12 from a plurality of documents 10 into a standard format quickly and accurately.

A user 104 accesses the generative AI system 102 using a device 106. In some implementations, the generative AI system 102 is local to the device 106 of the user 104. In some implementations, the generative AI system 102 is on a cloud server remote from the device 106 of the user 104 accessed through a network. For example, the generative AI system 102 is hosted on virtual machines in the cloud. For example, a uniform resource locator (URL) configured to an end point of the generative AI system 102 is provided to the device 106 that the user 104 may access using a browser on the device 106 through the network. The network may include one or multiple networks and may use one or more communication platforms and/or technologies suitable for transmitting data. The network may refer to any data link that enables transport of electronic data between devices of the environment 100. The network may refer to a hardwired network, a wireless network, or a combination of a hardwired network and a wireless network. In one or more implementations, the network includes the internet. The network may be configured to facilitate communication between the various computing devices via well-site information transfer standard markup language (WITSML) or similar protocol, or any other protocol or form of communication. Another example includes an application on the device 106 of the user 104 provides access to the generative AI system 102.

In some implementations, the user 104 provides one or more documents 10 with data 12 to the generative AI system 102. In some implementations, the data 12 is semi-structured data. In some implementations, the data 12 is unstructured data. In some implementations, the data 12 is structured data 16. In some implementations, the documents 10 are local to the device 106. In some implementations, the documents 10 are in datastores remote from the device 106.

In some implementations, the user 104 opens a window of a data management assistant 14 within the generative AI system 102 using the device 106 and provides the documents 10 to the data management assistant 14. In some implementations, the data management assistant is a generative AI assistant. For example, the user 104 uploads the documents 10 to the data management assistant 14. Another example includes the user provides file names for the documents 10 to the data management assistant 14 and the data management assistant 14 accesses the documents 10.

In some implementations, an application automatically sends the documents 10 to the data management assistant 14 (e.g., documents 10 used in a workflow). In some implementations, the documents 10 include text. In some implementations, the documents 10 include images. In some implementations, the documents 10 include graphs. In some implementations, the documents 10 include tables. In some implementations, the documents 10 include text and images. In some implementations, the documents 10 include text and graphs. In some implementations, the documents include text and tables. In some implementations, the documents 10 include tables and graphs. In some implementations, the documents 10 include text, images, graphs, and tables.

The data management assistant 14 determines whether a document structure of the document 10 is a recognized document structure. In some implementations, the data management assistant 14 compares the document structure to stored parsing templates 24 in a document parser datastore 112. If a match occurs between the document structure and a stored parsing templates 24, the data management assistant 14 uses the stored parsing templates 24 to import the data 12 from the document 10 into structured data 16. The document structure is a recognized document structure if the data management assistant 14 successfully uses the stored parsing template 24 to generate the structured data 16. The document structure is an unrecognized structure if an error occurs during the use of the stored parsing template 24 to generate the structured data 16. If a match does not occur between the document structure and a stored parsing templates 24, the document structure is unrecognizable.

In some implementations, the data management assistant 14 creates a document snippet 18 for a document 10 in response to determining the document structure for the document 10 is unrecognizable. The document snippet 18 is a subset of the document 10. In some implementations, the document snippet 18 is the first fifty lines of text of the document 10.

The data management assistant 14 generates a prompt 20 with the document snippet 18 and instructions 22 for extracting information of the structure of the document 10 using the document snippet 18. In some implementations, the instructions 22 are fixed and used for each document 10. For example, the instructions 22 provide details for features to look for in the document 10 to identify the document structure (e.g., identify a line in the document 10 that includes a header, identify separators in the data 12, identify where a line starts in the document 10, identify where a line stops in the document 10, identify metadata in the document 10, etc.). Another example includes the instructions 22 provide specific information about the data 12 in the document (e.g., petrophysical parameters associated with a formation name in the data 12). Another example includes the instructions 22 provide details for the output (e.g., a format of the output, information to contain the output, etc.). The prompt 20 is created on demand for the document 10 with the instructions 22 using the document snippet 18 of the document 10.

The data management assistant 14 provides the prompt 20 to the generative AI model 110 and the generative AI model 110 generates a parsing template 26 for the document 10 using the document snippet 18 and the instructions 22 in the prompt 20. In some implementations, the generative AI model 110 is a large language model (LLM). Examples of the LLM include Generative Pre-trained Transformer (GPT) models (e.g., GPT-3 or GPT-4), LlaMA, and GEMINI.

The parsing template 26 is a set of code that is used in converting the data 12 from the document 10 into a standard format. The parsing template 26 is a configuration file that specifies information in the document. The parsing template 26 provides the structure of the document 10. For example, the parsing template 26 provides the header line of the document 10. Another example includes the parsing template 26 specifying the column separators (e.g., semicolons, periods, commas, or line breaks) in the document 10. Another example includes the parsing template 26 specifying the column names. Another example includes the parsing template 26 specifying units of measurement used in the document 10. Another example includes the parsing template 26 specifying at which line the data 12 starts in the document 10.

The data management assistant 14 receives the parsing template 26 for the document 10 from the generative AI model 110 and uses a sandbox system 114 in verifying an accuracy of the parsing template 26 generated by the generative AI model 110 for the document 10. The sandbox system 114 imports the data 12 from the document 10 using the parsing information (e.g., the document structure generated by generative AI model 110) in the parsing template 26. In some implementations, the sandbox system 114 is an environment that simulates importing data 12 from the document 10 using the information in the parsing template 26.

In some implementations, the sandbox system 114 generates structured data 16 for the document 10 in response to using the parsing template 26 to import the data 12 from the document 10. Structured data 16 is data that is organized in a consistent and standardized format. In some implementations, the structured data 16 obeys industry standards. Examples of industry standards include Open Subsurface Data Universe (OSDU) and Wellsite Information Transfer Standard Markup Language (WITSML). For example, the structured data 16 is in a common format that is used to analyze or process the structured data 16. One example of the structured data 16 is a standard tabular form. For example, the structured data 16 is organized in tables with rows and columns that define data attributes. The data management assistant 14 receives the structured data 16 from the sandbox system 114 and determines that the parsing template 26 generated for the document 10 is accurate.

The data management assistant 14 provides the structured data 16 to the device 106 of the user 104 in response to verifying the accuracy of the parsing template 26. In some implementations, the data management assistant 14 provides the structured data 16 to an application on the device 106 of the user 104 for use by the application (e.g., in a workflow or quantitative analysis). In some implementations, the structured data 16 is presented on a display 108 of the device 106. In some implementations, the data management assistant 14 provides the structured data 16 to a data store (e.g., an information management system) for future use in analysis or processing. In some implementations, the data management assistant 14 provides the parsing template 26 to the document parser datastore 112 for future use with new documents provided to the generative AI system 102.

In some implementations, the sandbox system 114 generates an error 28 in response to using the parsing template 26 to import the data 12 from the document 10. The error 28 indicates a problem occurred during use of the parsing template 26 and the sandbox system 114 is unable to import the data 12 using the parsing template 26. The generative AI system 102 receives the error 28 from the sandbox system 114 and determines that the parsing template 26 is inaccurate.

In some implementations, the data management assistant 14 creates an updated prompt 30 with new instructions 32, the error 28, and the document snippet 18 in response to determining that the parsing template 26 is inaccurate. The new instructions 32 provide instructions to the generative AI model 110 for creating a new parsing template 34 for the document 10 fixing the error 28 received from the sandbox system 114. The data management assistant 14 provides the updated prompt 30 to the generative AI model 110.

The generative AI model 110 receives the updated prompt 30 and creates a new parsing template 34 for the document 10 using the new instructions 32, the error 28, and the document snippet 18. The new parsing template 34 includes a revised data structure for the document 10.

The data management assistant 14 receives the new parsing template 34 and verifies an accuracy of the new parsing template 34 using the sandbox system 114. In some implementations, the data management assistant 14 provides the new parsing template 34 to the document parser datastore 112 for future use with new documents provided to the generative AI system 102 in response to the sandbox system 114 verifying the new parsing template 34 and generating structured data 16 for the document 10. In some implementations, the data management assistant 14 provides the structured data 16 to the device 106 in response to the sandbox system 114 verifying the new parsing template 34 and generating the structured data 16 for the document 10.

In some implementations, the generative AI model 110 is a multi-modal model capable of processing multi-modal input. For example, the generative AI model 110 is a visual language model (VLM). In some implementations, the document 10 contains images, and the generative AI model processes the images in the document 10 using one or more prompts 20 to generate structured data 16 from the document 10. The data management assistant 14 receives the structured data 16 and provides the structured data 16 to the device 106 in response to the generative AI model 110 generating the structured data 16 for the document 10. In some implementations, the generative AI model 110 is unable to generate structured data 16 for the document 10 and generates an error 28.

The environment 100 automatically converts the data 12 from the documents 10 into structured data 16 on demand so that the structured data 16 is available for use, for example, by the users 104 or other applications on the device 106.

In some implementations, one or more computing devices (e.g., servers and/or devices) are used to perform the processing of the environments 100. The one or more computing devices may include, but are not limited to, server devices, cloud virtual machines, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the generative AI system 102, the generative AI model 110, the sandbox system 114, and the document parser datastore 112 are implemented on a single device. Moreover, in some implementations, one or more subcomponent of the feature and functionalities discussed herein may be implemented are processed on different server devices of the same or different cloud computing networks. For example, the generative AI system 102, the generative AI model 110, the sandbox system 114, and/or the document parser datastore 112 are implemented across a plurality of devices.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

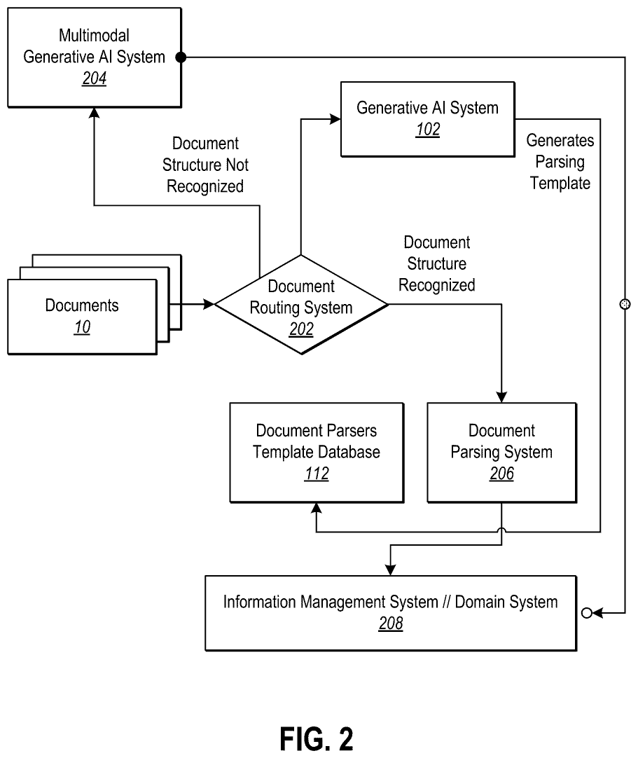

FIG. 2 illustrates an example environment 200 for using a multi-modal generative AI system 204 to import data 12 (FIG. 1) from documents 10 into a standard format. The environment 200 includes a document routing system 202 that receives the documents 10. In some implementations, the document routing system 202 receives the documents 10 from the user 104 (FIG. 1). For example, the user 104 selects the documents 10 to provide to the document routing system 202. Another example includes an application automatically sending the documents 10 to the document routing system 202.

The document routing system 202 determines whether the document structure of each document 10 is a recognized structure. The document routing system 202 routes the document 10 to the document parsing system 206 in response to determining the document structure of the document 10 is a recognized structure. In some implementations, the document parsing system 206 uses the document parsing datastore 112 to convert the data 12 from the document 10 into a standard format (e.g., the structured data 16 (FIG. 1)). For example, the document parsing system 206 selects a stored parsing template 24 (FIG. 1) from the document parsing datastore 112 that matches the document structure to use in converting the data 12 from the document 10 into a standard format. In some implementations, the document parsing system 206 provides the standard format data (e.g., the structured data 16) to an information management system 208 for use by the information management system 208.

In some implementations, the document routing system 202 determines whether the document contains text or contains multi-modal content in response to determining the document structure of the document 10 is unrecognizable. The document routing system 202 routes the document 10 to the generative AI system 102 in response to determining the document contains text. In some implementations, similar processing as that described in FIG. 1 occurs in the generative AI system 102.

In some implementations, the document routing system 202 routes the document 10 to the multi-modal generative AI system 204 in response to determining that the document 10 contains multi-modal modal content. For example, the document 10 includes images. The multi-modal generative AI system 204 provides a set of prompts 20 (FIG. 1) to a multi-modal generative AI model (e.g., the generative AI model 110 (FIG. 1)) to determine whether information can be extracted from an image in the document 10. In some implementations, the generative AI model 110 is a visual language model (VLM).

In some implementations, the prompt 20 includes instructions to the generative AI model 110 to convert the image into text and use the questions in the prompt 20 to extract the data 12 from the images in a standard format (e.g., the structured data 16). In some implementations, each prompt 20 includes different questions to ask the generative AI model 110 to use in identifying data 12 (FIG. 1) in the images. For example, a first prompt includes questions regarding geological information, a second prompt includes questions regarding formation pressure, and a third prompt includes questions about water sanity. The multi-modal generative AI system 204 provides each prompt to the generative AI model 110 to use in extracting the data 12 from the images in a standard format.

The multi-modal generative AI system 204 provides the standard format data (e.g., the structured data 16) to an information management system 208 for use by the information management system 208. In some implementations, the multi-modal generative AI system 204 is unable to extract the data 12 from the images in the document 10 using the prompts 20 and the generative AI model 110 outputs an error 28 (FIG. 1).

The environment 200 automatically converts multi-modal data 12 from the documents 10 into structured data 16 so that the structured data 16 is available for use, for example, by the information management system 208.

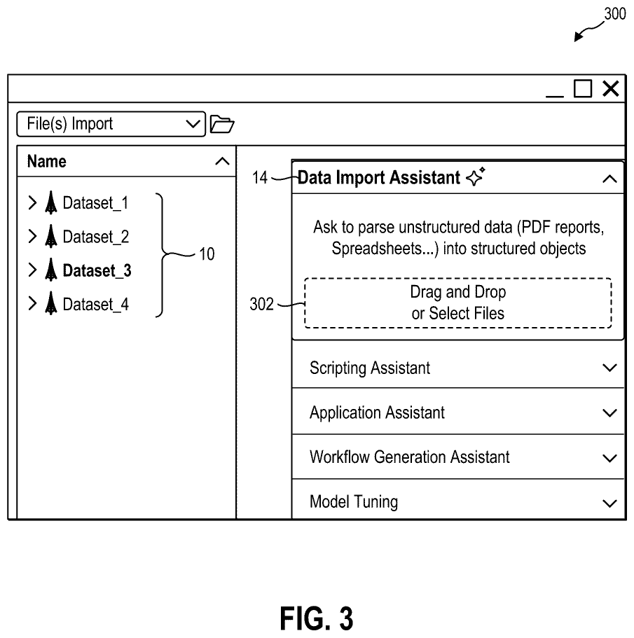

FIG. 3 illustrates an example graphical user interface (GUI) 300 of a data management assistant 14. The data management assistant 14 is an intelligent assistant that supports data conversion from documents 10. In some implementations, the user 104 (FIG. 1) accesses the GUI 300 on the display 108 (FIG. 1) of the device 106 (FIG. 1). In some implementations, the generative AI system 102 uses the data management assistant 14 to convert the data 12 (FIG. 1) from the documents 10 into structured data 16 (FIG. 1). In some implementations, the data management assistant 14 receives the documents 10 using the icon 302. For example, the user 104 drags and drops selected documents 10 onto the icon 302. The documents 10 are provided to the data management assistant 14 for use with the generative AI system 102. In some implementations, the documents 10 are provided to the data management assistant 14 for use with the multi-modal generative AI system 204 (FIG. 2). The GUI 300 provides an easy to use interface that the user 104 may access to easily convert data 12 from the selected documents on the fly into a standard format.

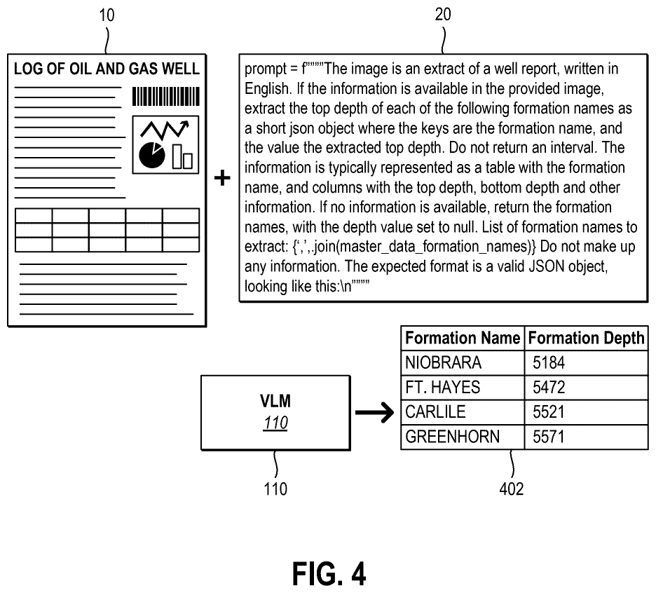

FIG. 4 illustrates an example output 402 generated by a generative AI model 110. In some implementations, the generative AI model 110 is a multi-modal generative AI model. For example, the multi-modal generative AI model is a visual language model. In some implementations, the multi-modal generative AI model is used by the generative AI system 102 (FIG. 1). In some implementations, the multi-modal generative AI model is used by the multi-modal generative AI system 204 (FIG. 2).

In some implementations, the document 10 is an image of a multipage well report that contains geological information. For example, the image includes formation information (e.g., formation names and a depth where the formation is located). For example, the user 104 drags and drops the document 10 into the generative AI system 102. The generative AI system 102 performs an optical character recognition (OCR) on the image identifying the page and area of the page that contains the geological information. In some implementations, the multi-modal generative AI system 204 performs the OCR on the image. The generative AI system 102 generates the prompt 20 with instructions 22 for extracting information from the area of the page that contains the geological information. For example, the instructions 22 request the formation depth in the attached image. The OCR optimizing the processing time and reduces a cost of the work (e.g., using less machine processing). In some implementations, the multi-modal generative AI system 204 generates the prompt 20 with the instructions 22.

In some implementations, the generative AI system 102 provides the prompt 20 to the generative AI model 110 with the instructions 22 for extracting information from the image. In some implementations, the multi-modal generative AI system 204 provides the prompt 20 to the generative AI model 110 with the instructions 22. The generative AI model 110 generates the output 402 in response to the instructions provided in the prompt 20. For example, the output 402 is information from the image of the well report in tabular form. The generative AI model 110 automatically extracts the formation name and formation depth from the image of the well report using the instructions in the prompt 20 and generates the table with the formation name and formation depth extracted from the image. In some implementations, the output 402 is in a standard format so that the information from the image of the well report can be used in performing a quantitative analysis of the well. For example, the output 402 is loaded into an application in a structured and directly consumable format.

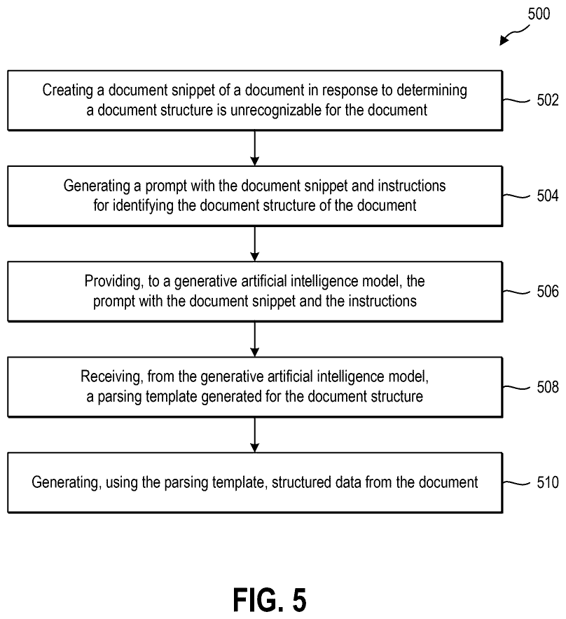

FIG. 5 illustrates an example method 500 for using for using a generative AI system 102 (FIG. 1) to automatically convert data 12 (FIG. 1) from documents 10 (FIG. 1) into a standard format. The actions of the method 500 are discussed below in reference to FIGS. 1-4.

At 502, the method 500 includes creating a document snippet of a document in response to determining a document structure is unrecognizable for the document. In some implementations, the generative AI system 102 creates a document snippet 18 of a document 10 in response to determining a document structure is unrecognizable for the document 10. The document snippet 18 is a subset of the document 10. In some implementations, the document snippet 18 is the first fifty lines of text of the document 10.

At 504, the method 500 includes generating a prompt with the document snippet and instructions for identifying the document structure of the document. In some implementations, the generative AI system 102 generates a prompt 20 with the document snippet 18 and instructions 22 for identifying the document structure of the document 10.

At 506, the method 500 includes providing, to a generative artificial intelligence model, the prompt with the document snippet and the instructions. In some implementations, the generative AI system 102 provides the prompt 20 with the document snippet 18 and the instructions 22 to a generative AI model 110. In some implementations, the generative AI model 110 is an LLM.

In some implementations, the generative AI model 110 is a multi-modal model and the document 10 includes an image. In some implementations, the generative AI system 102 generates a plurality of prompts 20 where each prompt includes instructions 22 for identifying data 12 in the image. The generative AI system 102 provides, to the multi-modal model, the document 10 and the plurality of prompts 20. The generative AI system 102 receives, from the multi-modal model, structured data 16 generated from the document 10 in response to the instructions in the plurality of prompts 20.

At 508, the method 500 includes receiving, from the generative artificial intelligence model, a parsing template generated for the document structure. In some implementations, the generative AI system 102 receives from the generative AI model 110, a parsing template 26 generated for the document structure. In some implementations, the parsing template 26 provides a set of code to automatically convert data 12 from the document 10 into a standard format. In some implementations, the structured data 16 is in the standard format.

In some implementations, the generative AI system 102 performs a simulation of using the parsing template 26 to generate the structured data 16 and verifies an accuracy of the parsing template 26 in response to the structured data 16 generated during the simulation. For example, the generative AI system 102 uses a sandbox system 114 to perform the simulation of using the parsing template 26.

In some implementations, the generative AI system 102 receives an error 28 during the simulation of using the parsing template 26. For example, the sandbox system 114 generates an error 28 during the simulation. The generative AI system 102 generates an updated prompt 30 with the error 28, the document snippet 18, and new instructions 32 for identifying the document structure of the document 10 and correcting the error 28. The generative AI system 102 receives a new parsing template 34 for the document structure from the generative AI model 110 and generates the structured data 16 using the new parsing template 34.

At 510, the method 500 includes generating, using the parsing template, structured data from the document. In some implementations, the generative AI system 102 uses the parsing template 26 to generate structured data 16 from the document 10. In some implementations, the structured data 16 is generated from the document 10 on the fly in response to the document 10 provided to the generative AI system 102. In some implementations, the generative AI system 102 generates the structured data 16 using the parsing template 26 in response to verifying that the parsing template 26 is accurate.

In some implementations, the method 500 optionally includes saving, in a datastore, the parsing template for the document structure. The generative AI system 102 stores the parsing template 26 for the document structure in the document parser datastore 112 for future use.

In some implementations, the method 500 optionally includes loading a stored parsing template for the document in response to determining the document structure is recognizable and generating, using the stored parsing template, the structured data from the document. For example, if the generative AI system 102 determines that the document structure of the document 10 is recognizable, a document parsing system 206 loads a stored parsing template 24 from the document parser datastore 112 and generates the structured data 16 from the document 10 using the stored parsing template 24.

In some implementations, the method 500 optionally includes using the structured data 16. For example, an information management system 208 receives the structured data 16 from the generative AI system 102 and uses the structured data 16 to analyze properties of an oil reservoir and modify a well design in response to the analysis of the oil reservoir. Another example includes the user 104 using the structured data 16 to perform asset evaluations. Another example includes an application using the structured data 16 to perform a workflow for the oil and gas industry.

The method 500 automates the conversion of data 12 from documents 10 into a common format.

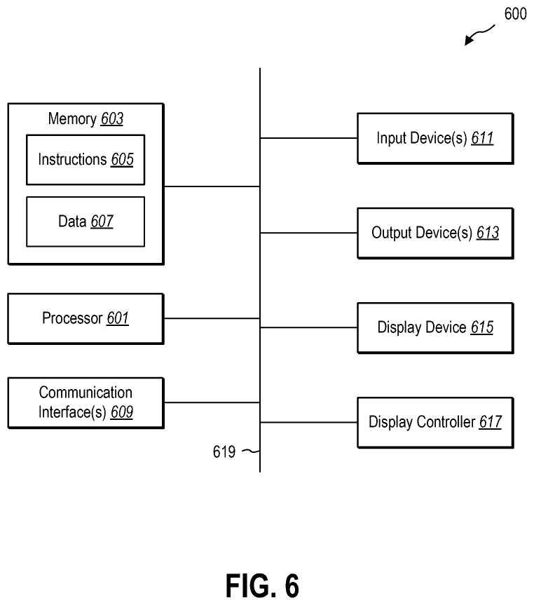

FIG. 6 illustrates components that may be included within a computer system 600. One or more computer systems 600 may be used to implement the various methods, devices, components, and/or systems described herein.

The computer system 600 includes a processor 601. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a graphics processing unit (GPU), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and light pen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

In some implementations, the various components of the computer system 600 are implemented as one device. For example, the various components of the computer system 600 are implemented in a mobile phone or tablet. Another example includes the various components of the computer system 600 implemented in a personal computer. Another example includes the various components of the computer system 600 implemented in the cloud. Another example includes the various components of the computer system 600 implemented on an edge device.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN), generative adversarial networks (GANs)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. There is no intention to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method comprising:
creating a document snippet of a document in response to determining a document structure is unrecognizable for the document;
generating a prompt with the document snippet and instructions for identifying the document structure of the document;
providing, to a generative artificial intelligence model, the prompt with the document snippet and the instructions;
receiving, from the generative artificial intelligence model, a parsing template generated for the document structure; and
generating, using the parsing template, structured data from the document.

2. The method of claim 1, wherein the parsing template provides a set of code to automatically convert data from the document into a standard format.

3. The method of claim 1, further comprising:
performing a simulation of using the parsing template to generate the structured data;
verifying an accuracy of the parsing template in response to the structured data generated during the simulation; and
generating, using the parsing template, the structured data in response to verifying the parsing template is accurate.

4. The method of claim 3, further comprising:
receiving an error during the simulation of using the parsing template;
generating an updated prompt with the error, the document snippet, and new instructions for identifying the document structure of the document and correcting the error;
providing, to the generative artificial intelligence model, the updated prompt;
receiving, from the generative artificial intelligence model, a new parsing template for the document structure; and
generating, using the new parsing template, the structured data from the document.

5. The method of claim 1, further comprising:
saving, in a datastore, the parsing template for the document structure.

6. The method of claim 1, further comprising:
loading a stored parsing template for the document in response to determining the document structure is recognizable; and
generating, using the stored parsing template, the structured data from the document.

7. The method of claim 1, further comprising:
analyzing, using the structured data, properties of an oil reservoir; and
modifying a well design in response to analyzing the oil reservoir.

8. The method of claim 1, wherein the generative artificial intelligence model is a large language model.

9. The method of claim 1, wherein the generative artificial intelligence model is a multi-modal model.

10. The method of claim 9, wherein the document includes an image, and the method further comprises:
generating a plurality of prompts where each prompt includes instructions for identifying data in the image;
providing, to the multi-modal model, the document and the plurality of prompts; and
receiving, from the multi-modal model, structured data generated from the document in response to the instructions in the plurality of prompts.

11. A device, comprising:
a memory to store data and instructions; and
a processor operable to communicate with the memory, wherein the processor is operable to:
create a document snippet of a document in response to determining a document structure is unrecognizable for the document;
generate a prompt with the document snippet and instructions for identifying the document structure of the document;
provide, to a generative artificial intelligence model, the prompt with the document snippet and the instructions;
receive, from the generative artificial intelligence model, a parsing template generated for the document structure; and
generate, using the parsing template, structured data from the document.

12. The device of claim 11, wherein the parsing template provides a set of code to automatically convert data from the document into a standard format.

13. The device of claim 11, wherein the processor is further operable to:
perform a simulation of using the parsing template to generate the structured data;
verify an accuracy of the parsing template in response to the structured data generated during the simulation; and
generate, using the parsing template, the structured data in response to verifying the parsing template is accurate.

14. The device of claim 13, wherein the processor is further operable to:
receive an error during the simulation of using the parsing template;
generate an updated prompt with the error, the document snippet, and new instructions for identifying the document structure of the document and correcting the error;
provide, to the generative artificial intelligence model, the updated prompt;
receive, from the generative artificial intelligence model, a new parsing template for the document structure; and
generate, using the new parsing template, the structured data from the document.

15. The device of claim 11, wherein the processor is further operable to:
save, in a datastore, the parsing template for the document structure.

16. The device of claim 11, wherein the processor is further operable to:
load a stored parsing template for the document in response to determining the document structure is recognizable; and
generate, using the stored parsing template, the structured data from the document.

17. The device of claim 11, wherein the processor is further operable to:
analyze, using the structured data, properties of an oil reservoir; and
modify a well design in response to analyzing the oil reservoir.

18. The device of claim 11, wherein the generative artificial intelligence model is a large language model.

19. The device of claim 11, wherein the generative artificial intelligence model is a multi-modal model.

20. The device of claim 19, wherein the document includes an image, and the processor is further operable to:
generate a plurality of prompts where each prompt includes instructions for identifying data in the image;
provide, to the multi-modal model, the document and the plurality of prompts; and
receive, from the multi-modal model, structured data generated from the document in response to the instructions in the plurality of prompts.
